(19) United States
(12) Patent Application Publication
(10) Pub. No.: US 2021/0325040 A1
(43) Pub. Date: Oct. 21, 2021

(54) EXHAUST PLUME ABATEMENT SYSTEMS AND METHODS

(71) Applicant: ENERVEX Inc., Alpharetta, GA (US)

(72) Inventor: John Andrew Campbell, Cumming, GA (US)

(21) Appl. No.: 16/852,423

(22) Filed: Apr. 18, 2020

(51) Int. Cl. F23J 15/06

(52) U.S. Cl. CPC F23J 15/06

(57) ABSTRACT

Exhaust plume abatement systems and methods are provided. A representative system, which is configured for use with a heating appliance, incorporates: a housing defining an interior chamber; an exhaust gas inlet configured to receive exhaust gas from the heating appliance; a first heat exchanger, disposed within the interior chamber; a dilution air inlet configured to receive dilution air from outside the housing; an exhaust gas outlet communicating with the interior chamber; wherein the interior chamber is configured to receive the exhaust gas from the exhaust gas inlet and the dilution air to form low humidity exhaust gas, which exhibits a lower humidity than the exhaust gas received from the heating appliance; and wherein the exhaust gas outlet is configured to output the low humidity exhaust gas with no visible exhaust plume.

### BACKGROUND

### Technical Field

The disclosure generally relates to the reduction of visible exhaust plumes associated with heating appliances.

### Description of the Related Art

Various heating appliances (boilers and water heaters, for example) produce flows or “plumes” of exhaust gas that are visible when the outdoor air temperature is low enough to drop the exhaust gas below the dew point before the exhaust gas can mix thoroughly with the atmosphere. With the trend towards higher efficiency heating appliances, associated exhaust gas temperatures have decreased. Unfortunately, the decrease in exhaust gas temperatures often results in visible exhaust plumes, which may be significantly problematic. In some applications, these exhaust plumes may lead to ice build-up on building walls, roofs, sidewalks, and adjacent streets. Compounding the issue is that many heating appliance installations use sidewall terminations, which can allow for visible exhaust plumes to obstruct the views of pedestrians and motorists, especially when installed in urban areas. It is, therefore, desirable to provide systems and methods that address these perceived deficiencies.

### SUMMARY

Exhaust plume abatement systems and methods are provided. An example embodiment of such a system, which is configured for use with a heating appliance, comprises: a housing defining an interior chamber; an exhaust gas inlet configured to receive exhaust gas from the heating appliance; a dilution air inlet configured to receive dilution air from outside the housing; an exhaust gas outlet communicating with the interior chamber; wherein the interior chamber is configured to receive the exhaust gas from the exhaust gas inlet and the dilution air to form low humidity exhaust gas, which exhibits a lower humidity than the exhaust gas received from the heating appliance; and wherein the exhaust gas outlet is configured to output the low humidity exhaust gas with no visible exhaust plume.

In some embodiments, a heat exchanger is disposed within the interior chamber that is configured to decrease a temperature of the exhaust gas until the temperature of the exhaust gas is at or below a dew point of water in the exhaust gas.

In some embodiments, a heat exchanger is disposed within the interior chamber that is configured to heat the dilution air to form heated dilution air.

In some embodiments, the heat exchanger is configured to receive heated water from the heating appliance.

Another example embodiment of a system comprises: a housing defining an interior chamber having a first compartment, a second compartment and a third compartment; an exhaust gas inlet, communicating with the first compartment, configured to receive exhaust gas from the heating appliance; a first heat exchanger, disposed within the first compartment, configured to decrease a temperature of the exhaust gas until the temperature of the exhaust gas is at or below a dew point of water in the exhaust gas; a condensate drain, communicating with the first compartment, configured to receive water condensed by the first heat exchanger from the exhaust gas and to direct the water outside of the housing; a dilution air inlet, communicating with the second compartment, configured to receive dilution air from outside the housing; a second heat exchanger, disposed within the second compartment, configured to heat the dilution air to form heated dilution air; and an exhaust gas outlet communicating with the third compartment; wherein the third compartment is configured to receive the exhaust gas from the first compartment and the heated dilution air from the second compartment to form low humidity exhaust gas, which exhibits a lower humidity than the exhaust gas received from the heating appliance; and wherein the exhaust gas outlet is configured to output the low humidity exhaust gas with no visible exhaust plume.

In some embodiments, an exhaust fan is disposed upstream of the exhaust gas outlet and is configured to expel the low humidity exhaust gas from the interior chamber.

In some embodiments, the first heat exchanger and the second heat exchanger are configured to circulate heat transfer fluid therebetween, with the heat transfer fluid being heated by the exhaust gas in the first compartment and the dilution air being heated by the heat transfer fluid in the second compartment.

In some embodiments, a third heat exchanger is disposed within the second compartment and configured to heat, along with the second heat exchanger, the dilution air to form heated dilution air.

In some embodiments, the third heat exchanger is configured to receive heated water from the heating appliance.

In some embodiments, the dilution air inlet extends through a sidewall of the housing; and the second heat exchanger and the third heat exchanger are oriented in a side-by-side arrangement with the second heat exchanger being positioned between the dilution air inlet and the third heat exchanger.

In some embodiments, the first compartment defines a first flow path and is configured to direct the exhaust gas along the first flow path upwardly toward the third compartment; and the second compartment defines a second flow path and is configured to direct the dilution air along the second flow path laterally toward the third compartment.

In some embodiments, the system further comprises a heating appliance heat exchanger configured to heat combustion air of the heating appliance; and the second heat exchanger and the heating appliance heat exchanger are configured to circulate heat transfer fluid therebetween.

In some embodiments, the first heat exchanger, the second heat exchanger and the heating appliance heat exchanger are configured such that the heat transfer fluid removes heat from the exhaust gas via the first heat exchanger, provides heat to the dilution air via the second heat exchanger, and provides heat to the combustion air of the heating appliance via the heating appliance heat exchanger.

In some embodiments, the system comprises the heating appliance.

In some embodiments, a condensate collector is disposed within the first compartment and below the first heat exchanger, the condensate collector having an upper surface inclined toward the condensate drain.

An example exhaust plume abatement method for use with a heating appliance, which is disposed within a building, comprises: receiving exhaust gas from the heating appliance; receiving dilution air; mixing the dilution air with the exhaust gas to form low humidity exhaust gas, which exhibits a lower humidity than the exhaust gas received from the heating appliance; and directing the low humidity exhaust gas from the building with no visible exhaust plume.

In some embodiments, prior to the mixing, a temperature of the exhaust gas is decreased until the temperature of the exhaust gas is at or below a dew point of water in the exhaust gas.

In some embodiments, prior to the mixing, the dilution air is heated to form heated dilution air.

In some embodiments, the heated dilution air is provided by a heat exchanger that is configured to receive heated water from the heating appliance.

Another example embodiment of a method comprises: receiving exhaust gas from the heating appliance; decreasing a temperature of the exhaust gas until the temperature of the exhaust gas is at or below a dew point of water in the exhaust gas; removing condensate from the exhaust gas when the temperature of the exhaust gas is at or below the dew point of water in the exhaust gas; receiving dilution air; heating the dilution air to form heated dilution air; mixing, after removing the condensate from the exhaust gas, the heated dilution air with the exhaust gas to form low humidity exhaust gas, which exhibits a lower humidity than the exhaust gas received from the heating appliance; and directing the low humidity exhaust gas from the building with no visible exhaust plume.

In some embodiments, decreasing a temperature of the exhaust gas comprises providing the exhaust gas to a first heat exchanger, which has a first heat transfer medium.

In some embodiments, heating the dilution air comprises providing the dilution air to a second heat exchanger.

In some embodiments, heating the dilution air further comprises heating the dilution air with heat transfer fluid, which is circulated between the heat exchanger and the second heat exchanger.

In some embodiments, the dilution air is received from outside the building.

In some embodiments, the dilution air is received from inside the building.

In some embodiments, the heating appliance provides heated water; and heating the dilution air comprises using the heated water from the heating appliance to heat the dilution air.

In some embodiments, heating the dilution air comprises providing the dilution air to a third heat exchanger; and the heating appliance provides the heated water to the third heat exchanger.

In some embodiments, a velocity of the low humidity exhaust gas is increased before being directed from the building.

Other objects, features, and/or advantages will become apparent from the following detailed description of the preferred but non-limiting embodiments. The following description is made with reference to the accompanying drawings.

### BRIEF DESCRIPTION OF THE DRAWINGS

FIG. 1 is a schematic diagram of an embodiment of an exhaust plume abatement system installed in a building.

FIG. 2 is a schematic diagram of an embodiment of an exhaust plume abatement system.

FIG. 3 is a flowchart depicting an embodiment of an exhaust plume abatement method.

FIG. 4A is a schematic diagram of another embodiment of an exhaust plume abatement system.

FIG. 4B is a schematic, cross-sectional diagram of the embodiment of FIG. 4A as viewed along section line 4B-4B.

FIG. 5 is a schematic diagram of another embodiment of an exhaust plume abatement system.

FIG. 6 is a schematic diagram of the embodiment of FIG. 5 with the door shown in the opened position.

FIG. 7A is a schematic diagram of the embodiment of FIGS. 5 and 6.

FIG. 7B is a schematic, cross-sectional diagram of the embodiment of FIG. 7A as viewed along section line 7B-7B.

FIG. 8 is a schematic diagram of the embodiment of FIGS. 5, 6, 7A and 7B showing the heating appliance.

### DETAILED DESCRIPTION

The following describes several embodiments of exhaust plume abatement systems and methods. It is to be understood that the invention is not limited in its application to the details of the particular arrangements shown since the invention is capable of other embodiments. Also, the terminology used herein is for the purpose of description and not of limitation.

Exhaust plume abatement systems and methods may reduce (or remove entirely) the amount of visible exhaust plume associated with a heating appliance (such as a CAT I, II, III, or IV heating appliance). In some embodiments, this is accomplished, at least in part, by decreasing the temperature of the exhaust gas exhausted from the heating appliance in order to promote condensation and removal of moisture from the exhaust gas. The exhaust gas then is mixed with dry dilution air (i.e., the dilution air that exhibits a relative humidity lower than that of the exhaust gas), thus, lowering the dew point of the exhaust gas-dilution air mixture. Preferably, the aforementioned functionality is provided by an integrated system that is configured to be installed between a heating appliance and its termination while offering a negligible degradation in efficiency of the heating appliance.

In this regard, an embodiment of an exhaust plume abatement system is depicted in FIG. 1. As shown in FIG. 1, exhaust plume abatement system 100 is installed in a building 102. Building 102 incorporates a mechanical room 104, in which a heating appliance 106 is located. Exhaust plume abatement system 100 is disposed within mechanical room 104 and configured to receive exhaust gas 108 from heating appliance 106.

Exhaust plume abatement system 100 includes a housing 110 that defines an interior chamber 112. An exhaust gas inlet 114 is configured to receive exhaust gas 108 from heating appliance 106 and provide exhaust gas 108 to interior chamber 112. A dilution air inlet 116 is configured to receive dilution air 118 from outside housing 110 and provide dilution air 118 to interior chamber 112. In some embodiments, dilution air 118 is drawn from outside building 102 (depicted by the solid arrow). In other embodiments, dilution air 118 may be drawn from an interior of the building, such as from mechanical room 104, for example (depicted by the dashed arrow 120).

Interior chamber 112 is configured to receive exhaust gas 108 from exhaust gas inlet 114 and dilution air 118 from dilution air inlet 116 to form low humidity exhaust gas 122. Specifically, exhaust gas 108 and dilution air 118 are mixed within interior chamber 112 to form low humidity exhaust gas 122, which exhibits a lower humidity than exhaust gas 108 as received from heating appliance 106. This is accomplished by the use of one or more heat exchangers that are disposed along either or both of the flow paths along which the exhaust gas and the dilution air flow within interior chamber 112.

An exhaust gas outlet 128 communicates with interior chamber 112 and is configured to output low humidity exhaust gas 122 from building 102 with no visible exhaust plume. In some embodiments, low humidity exhaust gas 122 is output via a roof 124 of building 102 (depicted by the solid arrow) whereas, in other embodiments, a side termination may be used (depicted by the dashed arrow 126).

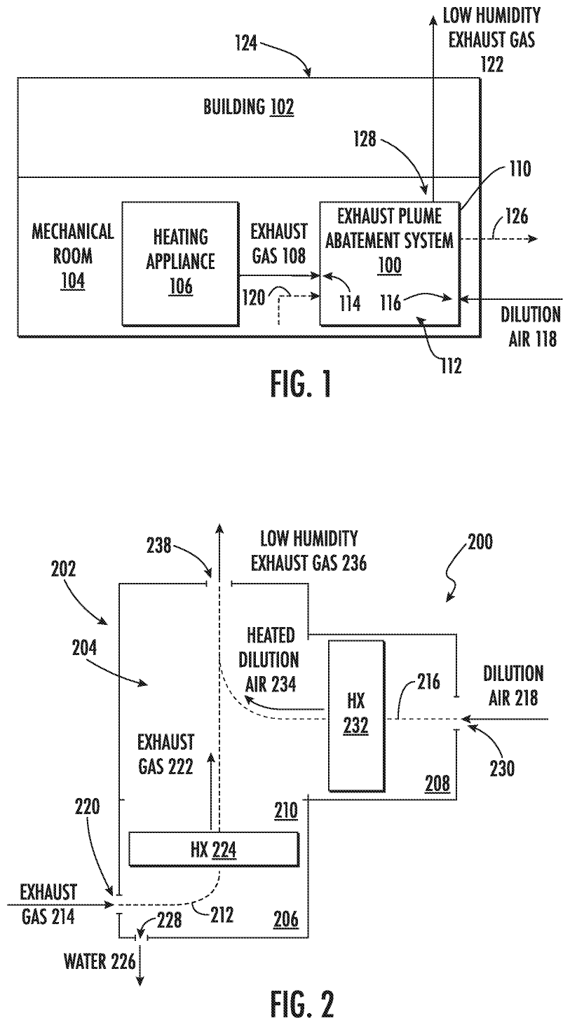

Another embodiment of an exhaust plume abatement system is depicted in FIG. 2. As shown in FIG. 2, exhaust plume abatement system 200 incorporates a housing 202 that defines an interior chamber 204, which includes a first compartment 206, a second compartment 208 and a third compartment 210. An exhaust gas inlet 220 communicates with first compartment 206 and, thus, is able to direct a flow of exhaust gas to interior chamber 204 from outside of housing 202. Specifically, exhaust gas inlet 220 is configured to receive a flow of exhaust gas 214 from a heating appliance (not shown) and direct the flow of exhaust gas 214 to first compartment 206. In some embodiments, first compartment 206 defines a first flow path 212 along which exhaust gas 214 is directed upwardly toward third compartment 210.

A heat exchanger 224 (which may be referred to herein as “an exhaust cooling heat exchanger”) is disposed within first compartment 206 between exhaust gas inlet 220 and third compartment 210 along first flow path 212. Heat exchanger 224 is configured to decrease a temperature of exhaust gas 214 until at or below a dew point of water in exhaust gas 214. This temperature drop causes at least some of the water vapor to condense into liquid water 226 that separates from the flow of exhaust gas 214. As such, moisture content of cooled exhaust gas 222 exiting heat exchanger 224 is reduced, which may be attributable to a corresponding reduction in exhaust gas plume. In some embodiments, heat exchanger 224 uses a chilled heat transfer medium (such as water or water and glycol, for example) to extract heat from exhaust gas 214. A condensate drain 228 communicates with first compartment 206 and is configured to receive water condensed by heat exchanger 224 from exhaust gas 214. Condensate drain 228, which is disposed at a bottom of first compartment 206 in this embodiment, directs water 226 outside of housing 202.

A dilution air inlet 230 communicates with second compartment 208 and, thus, is able to direct a flow of dilution air 218 to interior chamber 204 (i.e., to second compartment 208) from outside housing 202. In some embodiments, second compartment 208 defines a second flow path 216 along which dilution air 218 is directed laterally toward third compartment 210. A heat exchanger 232 (which may be referred to herein as “a dilution air heat exchanger”) is disposed within second compartment 208 between dilution air inlet 230 and third compartment 210 along second flow path 216. Heat exchanger 232 is configured to heat dilution air 218 to form heated dilution air 234.

In some embodiments, heat exchanger 232 and heat exchanger 224 use a heat transfer medium in a closed loop that is circulated between the heat exchangers. Such a configuration may allow for cooling of exhaust gas 214 by heat exchanger 224 and heating of dilution air 218 by heat exchanger 232. Specifically, dilution air 218 is passed through heat exchanger 232 and is heated by the heat transfer medium that extracted heat while in heat exchanger 224. Heat is removed from the heat transfer medium while heating dilution air 218 and the cooled heat transfer medium is returned to heat exchanger 224.

Third compartment 210 is configured to receive cooled exhaust gas 222 from first compartment 206 and heated dilution air 234 from second compartment 208 to form low humidity exhaust gas 236. Notably, within third compartment 210, cooled exhaust gas 222 and heated dilution air 234 mix to form low humidity exhaust gas 236, which exhibits a lower humidity than exhaust gas 214 exhibited when received from the heating appliance and, preferably, a lower humidity than cooled exhaust gas 222 exhibited when entering third compartment 210. Low humidity exhaust gas 236 is output via an exhaust gas outlet 238, which communicates with third compartment 210. Specifically, low humidity exhaust gas 236 is output with no visible exhaust gas plume.

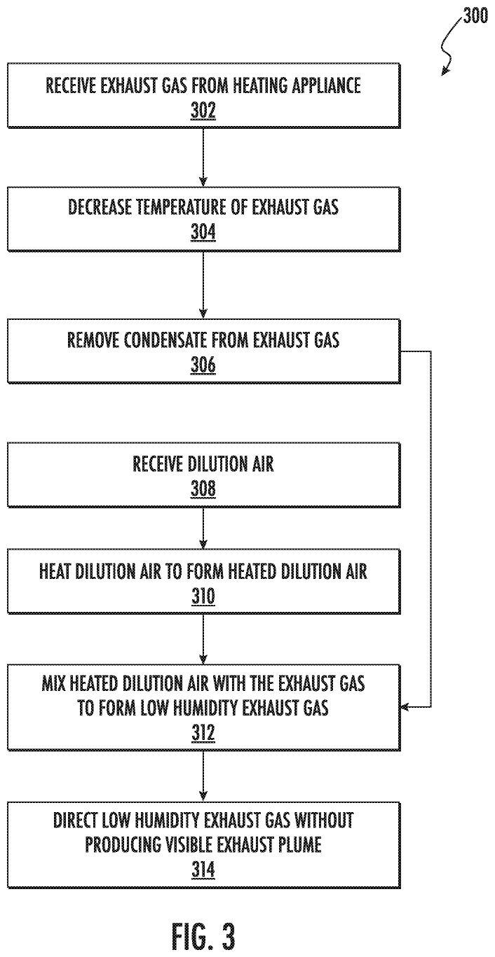

FIG. 3 is a flowchart depicting an embodiment of an exhaust plume abatement method, which may be construed in at least some respects as functionality associated with an embodiment of an exhaust plume abatement system. As shown in FIG. 3, method 300 may be construed as beginning in block 302, in which exhaust gas is received from a heating appliance. In block 304, a temperature of the exhaust gas is decreased until the temperature is at or below a dew point of water in the exhaust gas. In some embodiments, decreasing the temperature of the exhaust gas may be accomplished by providing the exhaust gas to a heat exchanger that uses a heat transfer medium. Then, as shown in block 306, condensate is removed from the exhaust gas when the temperature of the exhaust gas is at or below the dew point, thus reducing the moisture content of the exhaust gas.

In block 308, dilution air is received. In some embodiments, the dilution air is received from outside a building within which the heating appliance is disposed. In other embodiments, the dilution air is received from inside the building. Regardless of the origins of the dilution air, the dilution air is heated to form heated dilution air (block 310). In some embodiments, heating the dilution air involves providing the dilution air to a second heat exchanger. In some of these embodiments, the heat transfer fluid used for heating the dilution air is circulated between the heat exchanger (which extracts heat from the exhaust gas in block 304) and the second heat exchanger. Additionally or alternatively, the dilution air may be heated using heat (for example, heated water) from the heating appliance.

As shown in block 312, the heated dilution air is mixed with the exhaust gas (after at least some moisture has been removed (block 306)) to form low humidity exhaust gas. Notably the low humidity exhaust gas exhibits a lower humidity than the exhaust gas received from the heating appliance. The low humidity exhaust gas is then directed from the building with no visible exhaust plume (block 314). In some embodiments, a velocity of the low humidity exhaust gas is increased (such as by use of an exhaust fan) before directing the low humidity exhaust gas from the building.

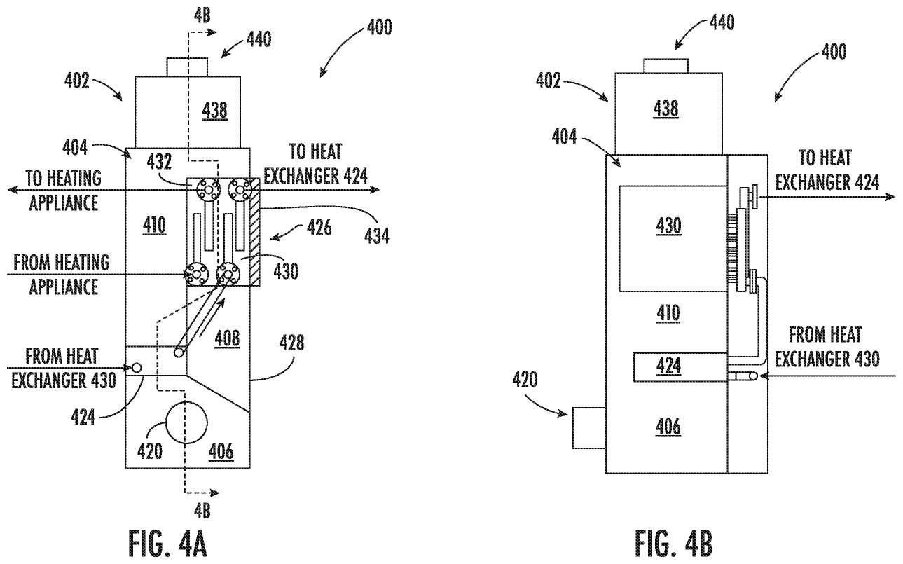

FIGS. 4A and 4B depict another embodiment of an exhaust plume abatement system. In particular, as shown in FIGS. 4A and 4B, exhaust plume abatement system 400 incorporates a housing 402 that defines an interior chamber 404, which includes a first compartment 406, a second compartment 408 and a third compartment 410. An exhaust gas inlet 420 communicates with first compartment 406 and is configured to direct a flow of exhaust gas to first compartment 406 from outside of housing 402.

A heat exchanger 424 is disposed within first compartment 406 and is configured to decrease a temperature of exhaust gas until at or below a dew point of water in the exhaust gas. Heat exchanger 424 uses a heat transfer medium (such as water or water and glycol, for example) to extract heat from the exhaust gas.

A dilution air inlet 426 communicates with second compartment 408 and is configured to direct a flow of dilution air to second compartment 408 from outside housing 402. In this embodiment, dilution air inlet 426 extends through a sidewall 428 of housing 402. Heat exchangers 430 and 432, oriented in a side-by-side arrangement in this embodiment, are disposed within second compartment 408. Both heat exchangers 430 and 432 are configured to heat dilution air to form heated dilution air; however, each may be configured to use a different heat source. By way of example, heat exchanger 430 may be configured to circulate a heat transfer medium to/from heat exchanger 424, whereas heat exchanger 432 may be configured to circulate a heat transfer medium to/from a heating appliance (e.g., the heating appliance from which the exhaust gas is received).

In some embodiments, a controller (not shown) is provided to monitor external atmospheric temperature and control the circulation of the heat transfer mediums to/from the heat exchangers. In some embodiments, when the external atmospheric temperature corresponds to a first set point, circulation of the heat transfer medium to/from heat exchanger 432 (and heating appliance) may be discontinued by the controller. When the external atmospheric temperature reaches a second (higher) set point, the controller may be configured to discontinue circulation of the heat transfer medium to/from heat exchanger 430. The temperature set points may be edited depending on the requirements of a particular installation.

A damper assembly 434 is disposed adjacent to dilution air inlet 426 to control the flow of dilution air. By way of example, in some embodiments, damper assembly 434 is configured as an on/off damper that provides the option to remove the dilution air when it is not needed. In some embodiments, the controller may additionally close damper assembly 434 and/or reduce fan speed to reduce power consumption.

Third compartment 410 is configured to receive and mix exhaust gas from first compartment 406 and heated dilution air from second compartment 408 to form low humidity exhaust gas. An exhaust fan 438, disposed upstream of an exhaust gas outlet 440, is configured to draw the low humidity exhaust gas from interior chamber 404 and expel the low humidity exhaust gas from housing 402. Preferably, the low humidity exhaust gas is output with no visible exhaust gas plume.

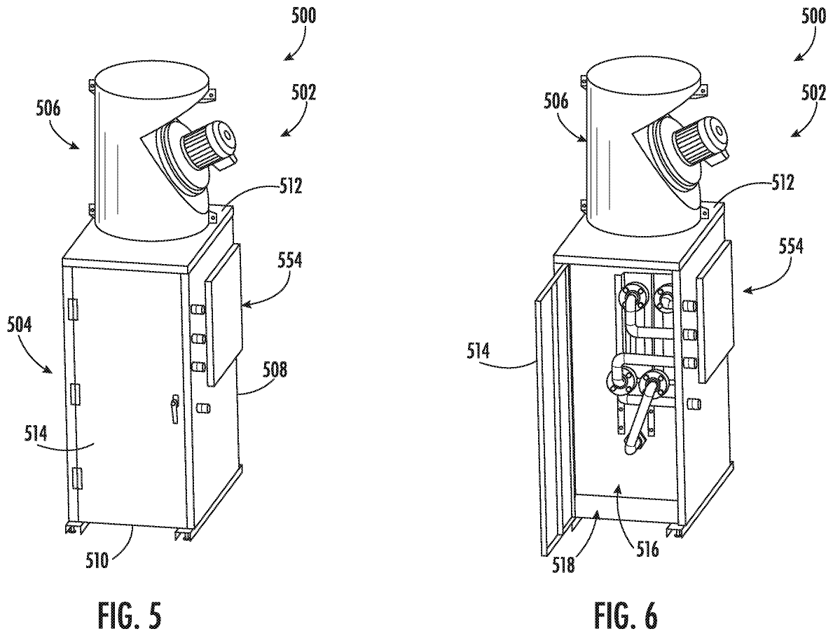

FIGS. 5, 6, 7A, 7B and 8 depict another embodiment of an exhaust plume abatement system. As will be described in detail below, exhaust plume abatement system 500 is capable of various configurations (such as number of heat exchangers and heat transfer medium routings, for example) based on the needs of a particular application.

Exhaust plume abatement system 500 incorporates a housing 502 that, in this embodiment, includes a base housing 504 and an exhaust fan housing 506. By way of example, exhaust fan housing 506 and its associated exhaust fan may be as that disclosed in commonly owned U.S. Patent Application Publication 2012/0083194, the entire contents of which are incorporated herein by reference.

Base housing 504 in this embodiment is generally rectangular in both vertical and horizontal cross-sections and incorporates rectangular sidewalls (e.g., sidewall 508), bottom 510 and top 512. As shown in FIG. 5 (which depicts a closed position) and FIG. 6 (which depicts an opened position), a door 514 is provided that offers access to an interior chamber 516 defined by housing 502. In particular, door 514 provides entry to a non-air-handling compartment 518 of interior chamber 516, enabling access to various heat exchangers and associated conduit.

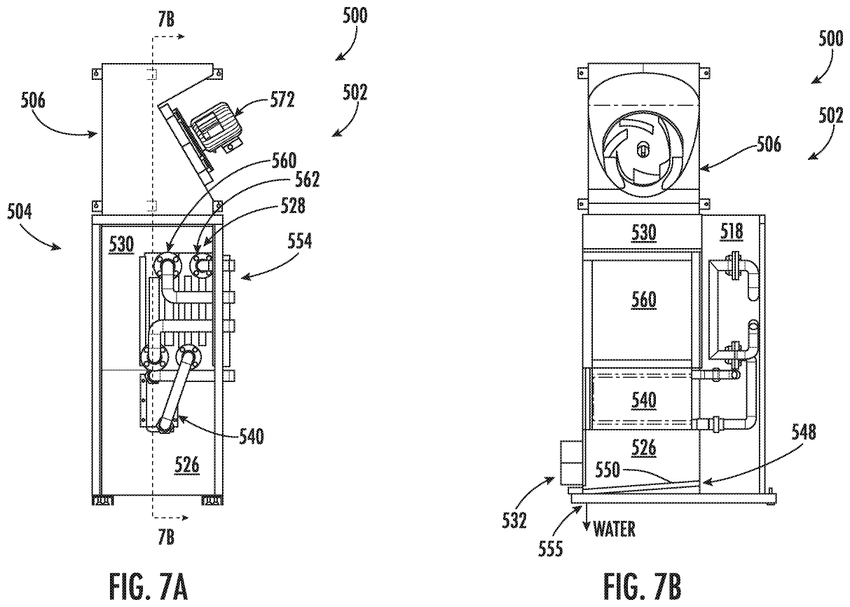

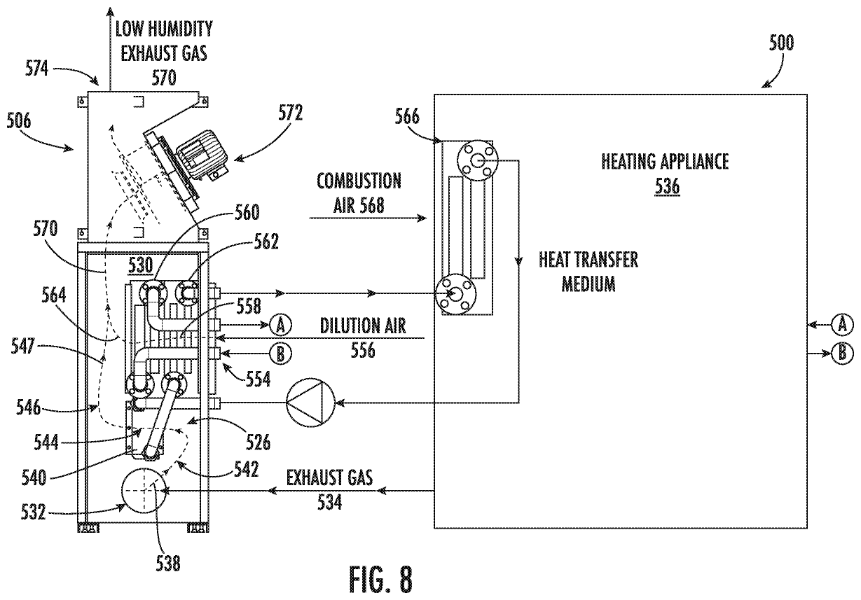

As best shown in FIGS. 7A, 7B and 8, interior chamber 516 also includes a first compartment 526, a second compartment 528 and a third compartment 530 that function as air-handling compartments. An exhaust gas inlet 532 communicates with first compartment 526 and is configured to direct a flow of exhaust gas 534 from a heating appliance 536 to first compartment 526. First compartment 526 defines a first flow path 538 (FIG. 8) along which exhaust gas 534 is directed upwardly toward third compartment 530.

A heat exchanger 540 is disposed within first compartment 526 between exhaust gas inlet 532 and third compartment 530 along first flow path 538. In this embodiment, owing to a vertical orientation of heat exchanger 540, first flow path 538 exhibits a first portion 542 upwardly directed from exhaust gas inlet 532, a second portion 544 laterally directed through heat exchanger 540, and a third portion 546 upwardly directed toward third compartment 530. Heat exchanger 540 is configured to decrease a temperature of exhaust gas 534 until at or below a dew point of water in exhaust gas 534. This temperature drop is facilitated to cause at least some of the water vapor in exhaust gas 534 to condense into liquid water that separates from the flow of the exhaust gas. So configured, cooled exhaust gas 547 exiting heat exchanger 540 exhibits a lower moisture content than that of exhaust gas 534 received from heating appliance 536.

A condensate collector 548 (FIG. 7B) is disposed within first compartment 526 below heat exchanger 540. In this embodiment, condensate collector 548 incorporates an upper surface 550 that is downwardly inclined toward a condensate drain 552, which is configured to direct water outside housing 502.

A dilution air inlet 554 communicates with second compartment 528 and is configured to direct a flow of dilution air 556 to second compartment 528 from outside housing 502. Second compartment 528 defines a second flow path 558 along which dilution air 556 is directed laterally toward third compartment 530. Heat exchangers 560 and 562 are disposed within second compartment 528 between dilution air inlet 554 and third compartment 530 along second flow path 558. Heat exchangers 560 and 562 are configured to heat dilution air 556 to form heated dilution air 564.

As shown in FIG. 8, heating appliance 536 incorporates a heating appliance heat exchanger 566 that is configured to heat combustion air 568 of the heating appliance. Heat transfer fluid may be circulated from heat exchanger 562 to heating appliance heat exchanger 566 in order to increase a temperature of combustion air 568. Additionally, the heat transfer fluid may be circulated from heating appliance heat exchanger 566 to remove heat from exhaust gas 534 via heat exchanger 540 and then circulated to heat exchanger 562 to heat dilution air 556. Further, heat exchanger 562 may use a heat transfer medium received from heating appliance 536, such as heated boiler water.

Third compartment 530 is configured to receive exhaust gas 547 and heated dilution air 564 to form low humidity exhaust gas 570, which exhibits a lower humidity than exhaust gas 534 exhibited when received from heating appliance 536 and, preferably, a lower humidity than exhaust gas 547 exhibited when entering third compartment 530. Low humidity exhaust gas 570 is directed via exhaust fan housing 506 and an associated exhaust fan 572 to exhaust gas outlet 574. Preferably, low humidity exhaust gas 570 is output with no visible exhaust gas plume.

As mentioned previously, exhaust plume abatement system 500 is capable of various configurations based on the needs of a particular application. The following describes general characteristics of several non-limiting configurations.

In a first configuration, exhaust plume abatement system 500 may be configured to use (and have installed within housing 502) only an exhaust cooling heat exchanger (e.g., heat exchanger 540) with a chilled heat transfer medium in order to reduce the exhaust temperature of entering exhaust gas to a temperature below the dew point. So provided, a portion of the water vapor in the exhaust gas condenses into a liquid, thus reducing the available moisture in the exhaust gas and corresponding size/extent of the associated exhaust gas plume. The cooled exhaust gas and heated dilution air are mixed before flowing through the exhaust fan and out of the termination (e.g., chimney system).

In a second configuration, exhaust plume abatement system 500 may be configured to use (and have installed within housing 502) only an exhaust cooling heat exchanger (e.g., heat exchanger 540) and a dilution air heat exchanger (e.g., heat exchanger 562). In operation, a closed loop of heat transfer medium is circulated from the exhaust cooling heat exchanger to the dilution air heat exchanger. This allows for moderate cooling of the exhaust gas and moderate heating of the dilution air. By reducing the exhaust gas temperature to below the dew point, a portion of the water vapor in the exhaust gas condenses out of the exhaust gas flow. Dilution air is passed through the dilution air heat exchanger and is heated by the heat transfer medium exiting the exhaust cooling heat exchanger. Heat is removed from the heat transfer medium while heating the dilution air and this cooled heat transfer medium is returned to the exhaust cooling heat exchanger. The cooled exhaust gas and heated dilution air are then mixed and output.

In a third configuration, exhaust plume abatement system 500 may be configured to use (and have installed within housing 502) an exhaust cooling heat exchanger (e.g., heat exchanger 540) and two dilution air heat exchangers (e.g., heat exchangers 560 and 562). In operation, a closed loop of heat transfer medium is circulated from the exhaust cooling heat exchanger to one of the dilution air heat exchanger as described before. Another heat transfer medium (e.g., boiler loop water) is pumped through the other dilution air heat exchanger to further increase the temperature of the dilution air. The cooled exhaust gas and heated dilution air are then mixed and output.

In a fourth configuration, exhaust plume abatement system 500 may be configured to use (and have installed within housing 502) only an exhaust cooling heat exchanger (e.g., heat exchanger 540) and a dilution air heat exchanger (e.g., heat exchanger 560). In operation, the exhaust cooling heat exchanger with a chilled heat transfer medium is used to reduce the exhaust temperature of entering exhaust gas to a temperature below the dew point. Additionally, another heat transfer medium is pumped through the dilution air heat exchanger to increase the temperature of the dilution air. The cooled exhaust gas and heated dilution air are then mixed and output.

In a fifth configuration, exhaust plume abatement system 500 may be configured to use (and have installed within housing 502) an exhaust cooling heat exchanger (e.g., heat exchanger 540) and a dilution air heat exchanger (e.g., heat exchanger 562) that operate in conjunction with a heating appliance heat exchanger (e.g. heat exchanger 566). In operation, a heat transfer medium is circulated from the exhaust cooling heat exchanger to the dilution air heat exchanger. From the dilution air heat exchanger, the heat transfer medium is circulated to the heating appliance heat exchanger to increase a temperature of combustion air of the heating appliance, which increases efficiency of the heating appliance and cools the heat transfer medium. The heat transfer medium is then circulated back to the exhaust cooling heat exchanger, thus completing the closed loop. The cooled exhaust gas from the exhaust cooling heat exchanger and heated dilution air from the dilution air heat exchanger are then mixed and output.

In a sixth configuration, exhaust plume abatement system 500 may be configured to use (and have installed within housing 502) only a dilution air heat exchangers (e.g., heat exchanger 560). In operation, heat transfer medium (e.g., boiler loop water) is pumped through the dilution air heat exchanger to increase the temperature of dilution air. The exhaust gas and heated dilution air are then mixed and output.

In a seventh configuration, exhaust plume abatement system 500 may be configured to use (and have installed within housing 502) an exhaust cooling heat exchanger (e.g., heat exchanger 540) and two dilution air heat exchangers (e.g., heat exchangers 560 and 562) that operate in conjunction with a heating appliance heat exchanger (e.g. heat exchanger 566). In operation, a heat transfer medium is circulated from the exhaust cooling heat exchanger to a first of the dilution air heat exchangers. From the first dilution air heat exchanger, the heat transfer medium is circulated to the heating appliance heat exchanger to increase a temperature of combustion air of the heating appliance. The heat transfer medium is then circulated back to the exhaust cooling heat exchanger. Another heat transfer medium (e.g., boiler loop water) is pumped through the second dilution air heat exchanger to further increase the temperature of the dilution air. The cooled exhaust gas and heated dilution air are then mixed and output.

As described above, various embodiments of exhaust plume abatement systems and methods decrease the temperature of exhaust gas exhausted from a heating appliance in order to promote condensation and removal of moisture from the exhaust gas. The exhaust gas then is mixed with relatively dry dilution air and output in a manner that may reduce (or remove entirely) the amount of visible exhaust plume associated with the heating appliance. This methodology is in direct contrast to the methodology employed by conventional cooling towers with plume abatement. In particular, a conventional cooling tower often includes a wet section followed by a dry section. In the wet section, exhaust gas passes through a spray of hot water, which not only heats the exhaust gas but provides the exhaust gas with high humidity (e.g., 100% relative humidity). The warm, humid exhaust gas then rises into the dry section. Air from outside the cooling tower is then heated to a temperature higher than that of the warm, humid exhaust gas and directed into the dry section for mixing, which reduces the relative humidity in the exhaust air. Thus, in contrast to a cooling tower that heats the exhaust gas and/or increases its humidity prior to mixing, embodiments of exhaust plume abatement systems and methods decrease the temperature of the exhaust gas exhausted in order to promote condensation and removal of moisture.

The embodiments described above are illustrative of the invention and it will be appreciated that various permutations of these embodiments may be implemented consistent with the scope and spirit of the invention.

1. An exhaust plume abatement system for use with a heating appliance, the system comprising:
a housing defining an interior chamber having a first compartment, a second compartment and a third compartment;
an exhaust gas outlet communicating with the third compartment;
an exhaust gas inlet, communicating with the first compartment, configured to receive exhaust gas from the heating appliance and direct the exhaust gas along a first flow path, which extends from the exhaust gas inlet, through the first compartment and the third compartment and to the exhaust gas outlet;
a first heat exchanger, disposed within the first compartment along the first flow path, configured to decrease a temperature of the exhaust gas until the temperature of the exhaust gas is at or below a dew point of water in the exhaust gas;
a condensate drain, communicating with the first compartment, configured to receive water condensed by the first heat exchanger from the exhaust gas and to direct the water outside of the housing;
a dilution air inlet, communicating with the second compartment, configured to receive dilution air from outside the housing and direct the dilution air along a second flow path, which extends from the dilution air inlet, through the second compartment and to the third compartment; and
a second heat exchanger, disposed within the second compartment along the second flow path, configured to heat the dilution air to form heated dilution air;
wherein the first heat exchanger and the second heat exchanger are configured to circulate heat transfer fluid therebetween, with the heat transfer fluid being heated by the exhaust gas in the first compartment and the dilution air being heated by the heat transfer fluid in the second compartment;
wherein the third compartment is configured to receive the exhaust gas from the first compartment and the heated dilution air from the second compartment to form low humidity exhaust gas, which exhibits a lower humidity than the exhaust gas received from the heating appliance, and is further configured to direct the low humidity exhaust gas along the first flow path; and
wherein the exhaust gas outlet is configured to output the low humidity exhaust gas with no visible exhaust plume.

2. The system of claim 1, further comprising an exhaust fan, disposed upstream of the exhaust gas outlet, configured to expel the low humidity exhaust gas from the interior chamber.

3. (canceled)

4. The system of claim 1, further comprising a third heat exchanger disposed within the second compartment and configured to heat, along with the second heat exchanger, the dilution air to form heated dilution air.

5. The system of claim 4, wherein the third heat exchanger is configured to receive heated water from the heating appliance.

6. The system of claim 4, wherein:
the dilution air inlet extends through a sidewall of the housing; and
the second heat exchanger and the third heat exchanger are oriented in a side-by-side arrangement with the second heat exchanger being positioned between the dilution air inlet and the third heat exchanger.

7. The system of claim 1, wherein:
the first compartment is configured to direct the exhaust gas along the first flow path upwardly toward the third compartment; and
the second compartment is configured to direct the dilution air along the second flow path laterally toward the third compartment.

8. The system of claim 1, wherein:
the system further comprises a heating appliance heat exchanger configured to heat combustion air of the heating appliance; and
the second heat exchanger and the heating appliance heat exchanger are configured to circulate heat transfer fluid therebetween.

9. The system of claim 8, wherein the first heat exchanger, the second heat exchanger and the heating appliance heat exchanger are configured such that the heat transfer fluid removes heat from the exhaust gas via the first heat exchanger, provides heat to the dilution air via the second heat exchanger, and provides heat to the combustion air of the heating appliance via the heating appliance heat exchanger.

10. The system of claim 1, further comprising the heating appliance.

11. The system of claim 1, further comprising a condensate collector disposed within the first compartment and below the first heat exchanger, the condensate collector having an upper surface inclined toward the condensate drain.

12. An exhaust plume abatement method for use with a heating appliance, which is disposed within a building, the method comprising:
receiving exhaust gas from the heating appliance;
decreasing a temperature of the exhaust gas along a first flow path with a first heat exchanger, which has a first heat transfer medium, until the temperature of the exhaust gas is at or below a dew point of water in the exhaust gas;
removing condensate from the exhaust gas when the temperature of the exhaust gas is at or below the dew point of water in the exhaust gas;
receiving dilution air;
circulating the heat transfer fluid between the first heat exchanger and a second heat exchanger disposed along a second flow path;
heating the dilution air with the second heat exchanger to form heated dilution air;
mixing, after removing the condensate from the exhaust gas, the heated dilution air from the second flow path with the exhaust gas from the first flow path to form low humidity exhaust gas, which exhibits a lower humidity than the exhaust gas received from the heating appliance; and
directing the low humidity exhaust gas from the building with no visible exhaust plume.

13.-15. (canceled)

16. The method of claim 12, wherein the dilution air is received from outside the building.

17. The method of claim 12, wherein the dilution air is received from inside the building.

18. The method of claim 12, wherein:
the heating appliance provides heated water; and
heating the dilution air further comprises using the heated water from the heating appliance to heat the dilution air.

19. The method of claim 18, wherein:
heating the dilution air comprises providing the dilution air to a third heat exchanger; and
the heating appliance provides the heated water to the third heat exchanger.

20. The method of claim 12, further comprising increasing a velocity of the low humidity exhaust gas before directing the low humidity exhaust gas from the building.
